(19) United States
(12) Patent Application Publication
(10) Pub. No.: US 2001/0053253 A1
(43) Pub. Date: Dec. 20, 2001

(54) Reclosable package having zipper closure, slider device and dual tamper-evident structures; and methods

(75) Inventors: James E. Buchman, Hortonville, WI (US); Paul A. Tilman, Sherwood, WI (US)

Correspondence Address: Thomas Trempus, Alcoa Technical Center, 100 Technical Drive, Alcoa Center, PA, 15069-0001, US

(73) Assignee: Reynolds Consumer Products, Inc.

(21) Appl. No.: 09/761,420

(22) Filed: Jan. 16, 2001

Related U.S. Application Data
(60) Provisional application No. 60/192,004, filed on Mar. 24, 2000.

(51) Int. Cl. B65D 33/25; B31B 1/84

(52) U.S. Cl. 383/5; 383/61; 383/64; 493/213

(57) ABSTRACT

A method of making packages having a reclosable zipper construction openable and closable by a slider device, and the packages made thereby. An extended length of zipper closure construction is used. The zipper closure construction consists of a zipper closure having first and second mating profiles, a first tamper evident-structure encasing the slider device and the zipper closure, and a second tamper evident-structure. Together, the first and second tamper evident-structure envelop the mating profiles and slider device. When incorporated into a package, the first tamper-evident structure encases the slider device and zipper closure, and the second tamper evident-structure is positioned between the mating profiles and the package interior.

Priority under 35 U.S.C. § 119(e) is claimed to provisional application Ser. No. 60/192,004, filed on Mar. 24, 2000, and entitled “Reclosable Package Having a Zipper Closure and A Slider Device, and Methods”. The complete disclosure of application Ser. No. 60/192,004 is incorporated by reference herein.

### FIELD OF THE DISCLOSURE

This disclosure concerns reclosable packages. In particular, this disclosure describes reclosable packages having slider devices for opening and closing the packages, and methods of manufacturing the packages.

### BACKGROUND

Flexible packages, in particular resealable and recloseable packages, are frequently used for packaging of consumable goods. Goods that are not used completely when the package is initially opened rely on a zipper closure to reclose the package and keep the remaining contents fresh. Examples of consumable goods that are often packaged in packages, such as bags, with a zipper closure include potting soil, fertilizer, pet food, dog biscuits, vegetables, cereal, and many different foods edible by humans.

Often, the opening and closing of the zipper closure is facilitated by a slider device that is mounted on the zipper closure. The slider device is constructed to pry apart the interlocking zipper closure members when the slider device is moved in a first direction along the zipper, and to engage the interlocking zipper closure members when the slider device is moved in a second, opposite direction along the zipper. For some applications, a tamper-evident structure, to notify whether access has been gained to the zipper closure, is desired. Improvements in these types of packages are desirable.

### BRIEF DESCRIPTION OF THE DRAWINGS

FIG. 1 is a perspective view of a flexible, reclosable package;

FIG. 2 is a partially schematic, cross-sectional view of the flexible, reclosable package taken along line 2-2 of FIG. 1;

FIG. 3 is a schematic, perspective view of an extended length of the zipper closure collected on a spool;

FIG. 4 is a partially schematic, cross-sectional view of a first embodiment of a zipper closure taken along line 3-3 of FIG. 3;

FIG. 5 is a partially schematic, cross-sectional view of a second embodiment of a zipper closure taken along line 3-3 of FIG. 3;

FIG. 6 is a partially schematic, cross-sectional view of a third embodiment of a zipper closure taken along line 3-3 of FIG. 3;

FIG. 7 is a partially schematic, cross-sectional view of a package incorporating the zipper closure of FIG. 4;

FIG. 8 is a schematic, perspective view of a vertical form, fill, and seal process for manufacturing and filling packages using an extended length of the zipper closure of FIG. 3; and

FIG. 9 is a schematic, perspective view of a horizontal form, fill, and seal process for manufacturing and filling packages using an extended length of the zipper closure of FIG. 3.

### SUMMARY OF THE DISCLOSURE

The present disclosure relates to a method of manufacturing a package, such as a flexible bag, having a resealable, reclosable zipper mechanism or closure; opening and closing of which is accomplished by a slider device mounted on the zipper mechanism. Prior to being incorporated into the package, the zipper closure is provided as an extended length with a membrane or envelope encasing the zipper closure. If the zipper closure is incorporated into a package, the membrane or envelope results in a first tamper evident-structure external to the zipper closure and a second tamper evident-structure internal to the zipper closure.

In particular, the present disclosure is directed to form, fill and seal processes that manufacture flexible packages having a reclosable zipper mechanism, fill the packages with items, and seal the filled packages. The zipper mechanism, the slider, and any seals are applied to the packages in the same process as filling of the packages. The form, fill, and seal processes can be a vertical process or a horizontal process.

In one particular embodiment, the present disclosure is directed to a method of making a resealable, reclosable package. The method includes providing an extended length of a zipper closure mechanism, sealing the extended length of zipper closure to a surrounding wall, and forming edges in the surrounding wall to form a package interior. The zipper closure mechanism includes a first interlocking closure profile and a second interlocking closure profile, each of the closure profiles having a distal end and a sealing flange opposite the distal end. A slider device is operably mounted on the zipper closure, the slider device being constructed and arranged to interlock the first closure profile with the second closure profile when the slider device is moved in a first direction, and to disengage the first closure profile from the second closure profile when the slider device is moved in a second opposite direction. The slider device is mounted on the distal ends of the closure profiles. A first tamper evident-structure, which envelopes the slider device and the distal ends of the closure profiles, and a second tamper evident-structure, which envelopes the sealing flanges, are also present in the reclosable package. A notch can be provided in the closure profiles to facilitate seating of the slider device on the zipper closure mechanism.

This disclosure also is directed to a resealable, reclosable package made by the methods of this disclosure. In one embodiment, the package has a surrounding wall defining a package interior and a zipper closure having a first interlocking closure profile and a second interlocking closure profile, each of the closure profiles having a distal end and a sealing flange disposed opposite the distal end. The zipper closure provides access to the package interior. A slider device is operably mounted on the distal ends of the first and second closure profiles to mate (interlock) and unmate (disengage) the closure profiles as desired. The slider device interlocks the first closure profile with the second closure profile when the slider device is moved in a first direction, and disengages the first closure profile from the second closure profile when the slider device is moved in a second opposite direction. The package further has a first tamper evident-structure encasing the distal ends of the closure profiles and the slider device, and also has a second tamper evident-structure positioned between the package interior and the closure profiles. The surrounding wall, which defines the interior, and the second tamper evident-structure are attached to one another.

This disclosure also relates to an extended length of a zipper closure, including slider devices mounted on the zipper closure, encased in an envelope or membrane. In one embodiment, the extended length includes a first interlocking closure profile and a second interlocking closure profile, each of the closure profiles having a distal end and a sealing flange disposed opposite the distal end. Slider devices are operably mounted on the first and second closure profiles at their distal ends. Each slider device interlocks the first closure profile with the second closure profile when the slider device is moved in a first direction, and disengages the first closure profile from the second closure profile when the slider device is moved in a second opposite direction. The envelope encasing the first and second closure profiles and the slider devices mounted thereon, has a first tamper evident-structure disposed over the slider device and the distal ends of the closure profiles, and a second tamper evident-structure. Both tamper evident-structures are connected to the sealing flanges of the closure profiles.

### DETAILED DESCRIPTION

The addition of a slider device to a flexible package, such as a plastic bag, is advantageous to aging or arthritic persons not having the physical ability to use just a zipper closure to reseal a bag. Additionally, the addition of a tamper-evident structure to the package is advantageous to notifying whether tampering has occurred to the package. The package of the present disclosure includes a slider device to open and close the package, and first and second tamper-evident structures to indicate whether access has been gained to the zipper closure and to the interior of the package. Prior to incorporation into the package, the zipper closure, slider device, and tamper-evident structures can be provided as an extended length, for example, on a roll or spool. The extended length of zipper closure can be utilized in various processes described herein, such as horizontal and vertical form, fill, and seal processes.

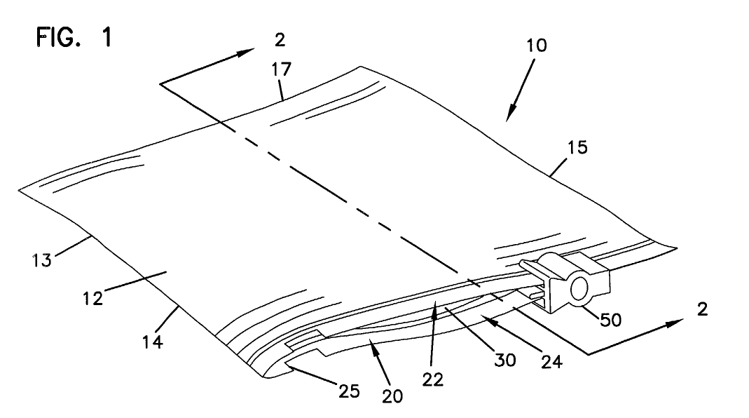

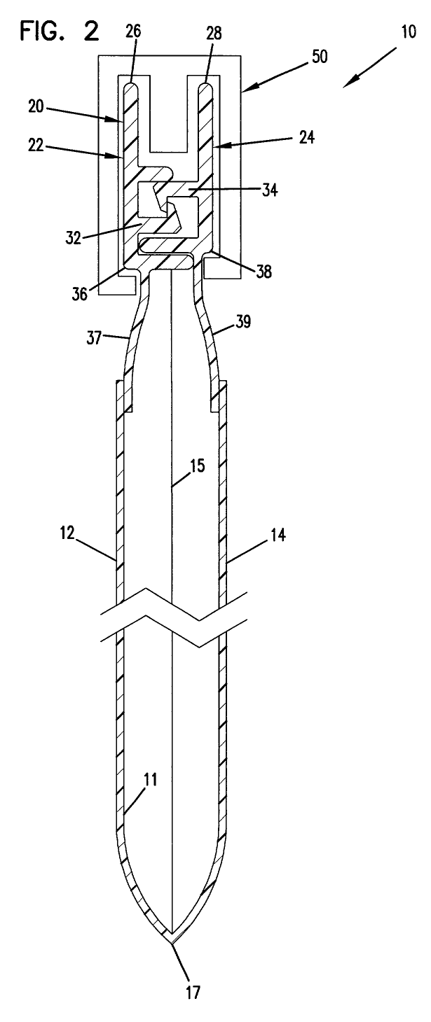

A flexible, reclosable package 10 having side panels 12 and 14 is shown in FIGS. 1 and 2. A surrounding wall, formed by side panels 12, 14, defines a package interior 11, shown in FIG. 2. Package 10 has side edges 13, 15 and bottom edge 17, which, with side panels 12, 14, define interior 11. A zipper closure arrangement 20, having mating profiles to open and close (unseal and reseal) the package 10, provides access to interior 11 via mouth 30 (FIG. 1). The zipper closure 20 can include a variety of configurations and structures. For example, the zipper closure 20 can be constructed according to U.S. Pat. Nos. 4,240,241; 4,246,288; or 4,437,293; each of which is incorporated by reference herein. The zipper closure 20 has a first mating profile 22 and a second mating profile 24 that engage and disengage, as appropriate, to open and close the package 10.

Zipper closure 20 is shown in detail in FIG. 2. First mating profile 22 includes a first mating member 32 with a distal end 26, a first shoulder 36, and a sealing flange 37; second mating profile 24 includes a second mating member 34 with a distal end 38, a second shoulder 38, and a sealing flange 39. First mating member 32 engages and disengages with second mating member 34.

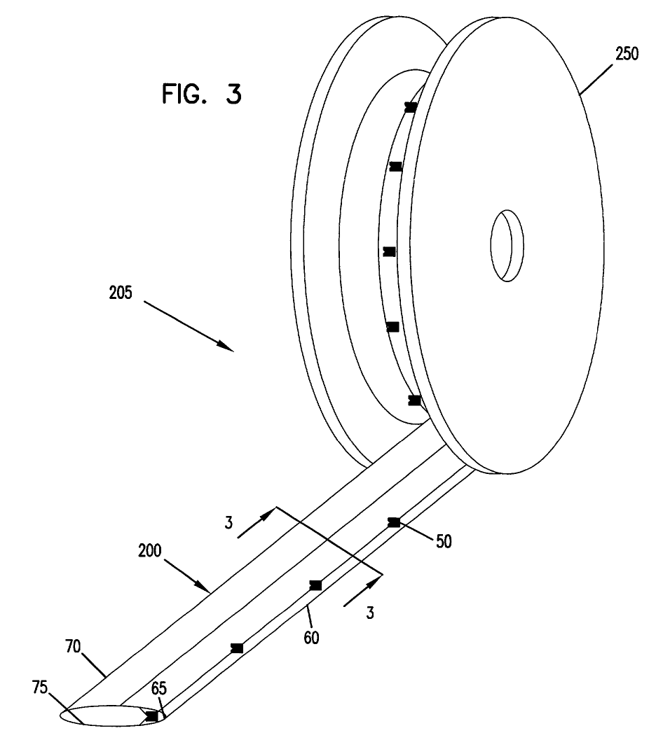

A slider device 50 is mounted on zipper closure 20 to facilitate opening and closing of zipper closure 20. In particular, slider device 50 is positioned over distal ends 26, 28 and is held onto zipper closure 20 by shoulders 36, 38 (FIG. 2) of first and second mating profiles 22, 24. Slider devices and how they function to open and close zipper closures, in general, are taught, for example, in U.S. Pat. Nos. 5,063,644; 5,301,394; and 5,442,837, each of which is incorporated by reference herein. A preferred slider device is taught in U.S. patent applications Ser. Nos. 09/365,215 and 29/108,657, both filed Jul. 30, 1999 and incorporated herein by reference in their entirety. Although shown schematically in FIGS. 1 and 2, and in FIGS. 3 through 8, slider device 50 is preferably constructed and arranged in accordance with the disclosures of patent applications Ser. Nos. 09/365,215 and 29/108,657.

A notch 25 (FIG. 1) is disposed within zipper closure 20 adjacent to first side edge 13 in the package 10. Notch 25 is designed to provide a “park place” into which slider device 50 settles when zipper closure 20 is sealed and slider device 50 is at the first edge 13. Such a notch 25 may decrease any tendency for an incomplete interlock between first mating profile 22 and second mating profile 24.

In accordance with the present disclosure, the zipper closure 20, prior to being incorporated into a package, is provided as an extended length. Referring to FIG. 3, an extended length of zipper closure 200 is illustrated wound on a spool 250. The resulting spool of zipper closure is shown at 205. The extended length of zipper closure 200 can be provided on a cored or coreless spool, bobbin, shuttle, or the like.

Further in accordance with the present disclosure, the extended length of zipper closure 200 is provided as first and second mating profiles 22, 24 (FIG. 2) encased by a first tamper-evident structure 60 and a second tamper-evident structure 70. By the use of the terms “encase”, “envelop”, “enclose”, “surround”, and the like, it is intended that the tamper evident-structures 60, 70, together with some other feature of mating profiles 22, 24, define and hold a volume around the zipper closure 20; the structure and function of tamper evident-structures 60, 70 are described in detail below.

First tamper evident-structure 60 surrounds and covers the distal ends 26, 28 (FIG. 2) of the first and second mating profiles 22, 24 so that the profiles cannot be separated without penetrating the tamper evident-structure 60. First tamper-evident structure 60 also covers slider device 50 which is mounted on mating profiles 22, 24. A first enclosure 65 (FIG. 3) is defined by first tamper evident-structure 60 and sealing flanges 37, 39 (FIG. 2). First tamper evident-structure 60 is not a structure that is commonly referred to as a “peel seal”; rather, tamper evident-structure 60 is a structure such as a membrane, film, web, or the like that extends over distal ends 26, 28 and slider device 50.

Preferably, after extended length of zipper closure 200 is incorporated into a package 10, first tamper evident-structure 60 encloses slider device 50 and the length of zipper closure 20 from first side edge 13 (FIG. 1) to second side edge 15 (FIG. 1) of package 10. First tamper evident-structure 60 is considered an “external” tamper evident-structure because it is positioned external to the zipper closure 20 in relation to the package interior 11 (FIG. 2).

Second tamper evident-structure 70 (FIG. 3) extends between sealing flanges 37, 39 (FIG. 2). A second enclosure 75 (FIG. 3) is defined by second tamper evident-structure 70 and sealing flanges 37, 39 (FIG. 2). Second tamper evident-structure 70 is not a structure that is commonly referred to as a “peel seal”; rather, tamper evident-structure 70 is a structure such as a membrane, film, web, or the like that provides a discernible length or distance between sealing flanges 37, 39.

After extended length of zipper closure 200 is incorporated into a package 10, second tamper-evident structure 70 is present between the profiles 22, 24 and package interior 11, so that if profiles 22, 24 have been opened and separated, access cannot be gained to the interior 11 (FIG. 2) of the package without penetrating second tamper evident-structure 70. Specifically, after zipper closure 20 has been opened, access is first gained to the second enclosure 75 prior to accessing package interior 11 (FIG. 2). Second tamper evident-structure 70 is considered an “internal” tamper evident-structure because it is positioned between the zipper closure 20 and the package interior 11.

Together, the first tamper evident-structure 60 and the second tamper evident-structure 70 encase, enlock, enshroud, cover, and otherwise envelop the zipper closure 20 from both sides (that is, from the distal ends 26, 28 and sealing flanges 37, 39). The tamper evident-structures 60, 70 create an enclosure or envelope around the closure profiles 22, 24 (FIG. 2) and the slider device 50 that is positioned on the closure profiles 22, 24.

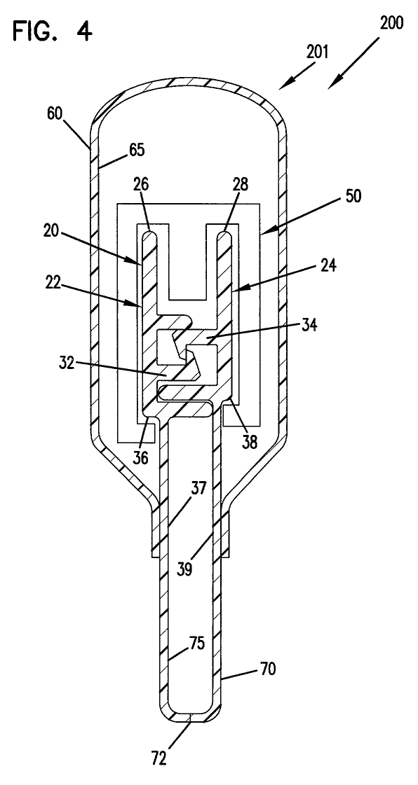

Various embodiments of extended lengths of zipper closure 200 are shown in cross section in FIGS. 4 through 6. Each extended length of zipper closure 200 has a first tamper evident-structure 60 and a second tamper evident-structure 70 extending around and encasing the closure profiles 22, 24 and slider device 50. Each of tamper evident-structures 60, 70 is not a “peel seal” structure; rather, tamper evident-structures 60, 70 are structures such as a membrane, film, web, or the like.

Referring to FIG. 4, extended length of zipper closure 200, specifically extended length of zipper closure 201, has zipper closure 20 encased by first tamper evident-structure 60 and second tamper evident-structure 70, creating first and second enclosures 65, 75. In particular, extended length of zipper closure 201 of FIG. 4 has second tamper evident-structure 70 formed integral with sealing flanges 37, 39. By the term “integral”, it is meant that tamper evident-structure 70 and sealing flanges 37, 39 are provided as a single, unitary member; there is no discernible break between sealing flanges 37, 39 and tamper evident-structure 70. First tamper evident-structure 60 is disposed over slider device 50 and is sealed to sealing flanges 37, 39.

In a preferred embodiment, extended length of zipper closure 201 is made by extruding a single structure that includes first and second mating profiles 22, 24 connected at their sealing flanges 37, 39. When mating profiles 22, 24 are interlocked via mating members 32, 34, the extension of material connecting sealing flanges 37, 39 provides second tamper evident-structure 70. First tamper evident-structure 60 is provided by applying a film or membrane over the distal ends 26, 28 of profiles 22, 24 and sealing the tamper evident-structure 60 preferably to either sealing flanges 37, 39 or to a portion of second tamper evident-structure 70. Slider device 50, and optionally notch 25 (FIG. 1), are provided on zipper closure 20 prior to attachment of tamper evident-structure 60.

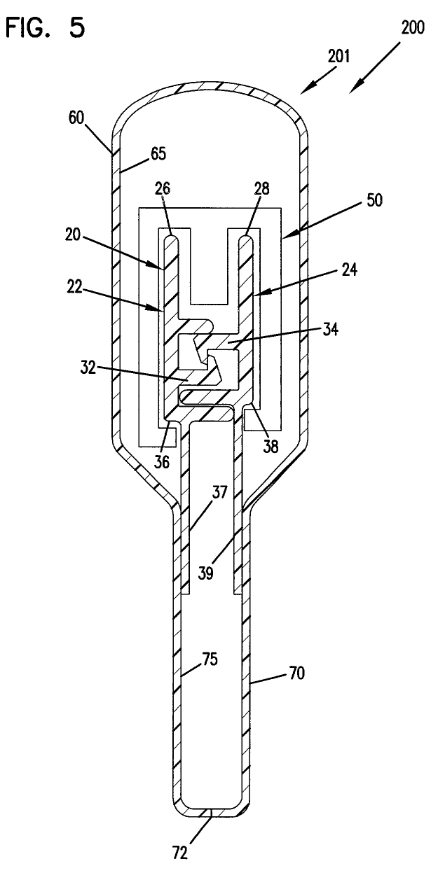

Referring to FIG. 5, extended length of zipper closure 200, specifically extended length of zipper closure 202, has zipper closure 20 encased by first tamper evident-structure 60 and second tamper evident-structure 70, creating first and second enclosures 65, 75. In particular, extended length of zipper closure 202 of FIG. 5 has first and second tamper evident-structures 60, 70 formed as a unitary structure positioned over zipper closure 20 and slider device 50. In a preferred embodiment, first and second tamper evident-structures 60, 70 are formed from a tube 67 of film material. Preferably, tube 67 is seamless. The material that provides first and second tamper evident-structures 60, 70 is sealed to sealing flanges 37, 39 to provide two individual tamper evident-structures 60, 70, each which must be penetrated to enable proper use of the package in which extended length of zipper closure 202 is incorporated.

In a preferred embodiment, extended length of zipper closure 202 is made by extruding or otherwise providing first and second mating profiles 22, 24, interlocking the profiles 22, 24 via mating members 32, 34, and then positioning the interlocked profiles 22, 24 within a tube material, such as tube 67, to form first and second tamper evident-structures 60, 70. The tamper evident-structure material is sealed to sealing flanges 37, 39, typically by the application of heat and pressure to the area of the desired seal.

First and second mating profiles 22, 24 can be extruded individually, that is, as two individual profiles; or, first and second mating profiles 22, 24 can be extruded connected at either distal ends 26, 28 or at sealing flanges 37, 39. If the mating profiles 22, 24 are connected, the two profiles 22, 24 are typically slit or otherwise separated before interlocking the mating members 32, 34.

Slider device 50, and optionally notch 25 (FIG. 1), are provided on zipper closure 20 prior to positioning zipper closure 20 and slider device 50 within tamper evident-structures 60, 70.

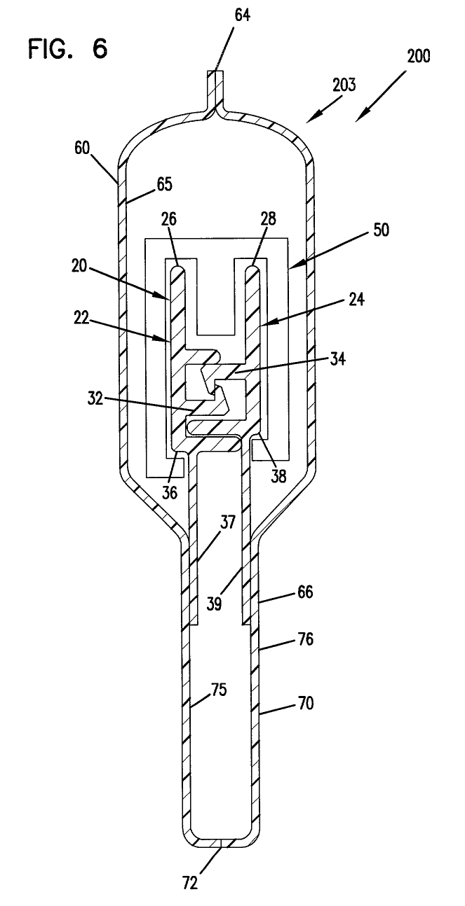

Referring to FIG. 6, extended length of zipper closure 200, specifically extended length of zipper closure 203, has zipper closure 20 encased by first tamper evident-structure 60 and second tamper evident-structure 70 creating first and second enclosures 65, 75. In particular, extended length of zipper closure 203 of FIG. 6 has first and second tamper evident-structures 60, 70 formed over zipper closure 20 and slider device 50. In a preferred embodiment, first and second tamper evident-structures 60, 70 are formed from a single piece of film material 66 that is sealed at a single seam 64 to provide first and second tamper evident-structures 60, 70. In the embodiment shown in FIG. 6, the seam 64 within film material 66 is positioned in the first tamper evident-structure 60; in another embodiment, the seam can be positioned in the second tamper evident-structure 70. The seam 64 may be positioned essentially in the center of tamper evident-structure 60, as shown in FIG. 6, or the seam can be positioned off-center. In some embodiments, the seam can be positioned on a sealing flange 37, 39. The material 66 that provides first and second tamper evident-structures 60, 70 is sealed to sealing flanges 37, 39 to provide two individual tamper evident-structures 60, 70, each which must be penetrated to have proper functioning of the zipper closure.

In a preferred embodiment, extended length of zipper closure 203 is made by extruding or otherwise providing first and second mating profiles 22, 24 and interlocking the profiles 22, 24 via mating members 32, 34. A single piece of material 66 is positioned around the interlocked profiles 22, 24 and the material 66 is sealed at seal 64 to provide a tube or loop 76. As stated above, the seam or seal 64 can be positioned at any point within first or second tamper evident-structure 60, 70. The tamper evident-structure material 66 is sealed to sealing flanges 37, 39, typically by the application of heat and pressure to the area of the desired seal. In some embodiments, profiles 22, 24 can be mated after the tamper-evident structure material 66 forms tamper-evident structures 60, 70.

First and second mating profiles 22, 24 can be extruded individually, that is, as two individual profiles; or, first and second mating profiles 22, 24 can be extruded connected at either distal ends 26, 28 or at sealing flanges 37, 39. If mating profiles 22, 24 are connected, the two profiles are typically slit or otherwise separated before interlocking the mating members 32, 34.

Slider device 50, and optionally notch 25 (FIG. 1), are provided on zipper closure 20 prior to positioning zipper closure 20 and slider device 50 within tamper evident-structures 60, 70. In some embodiments, in particular when the seam is located within first tamper evident-structure 60, second tamper evident-structure 70 may be made prior to placing slider device 50 on zipper closure 20.

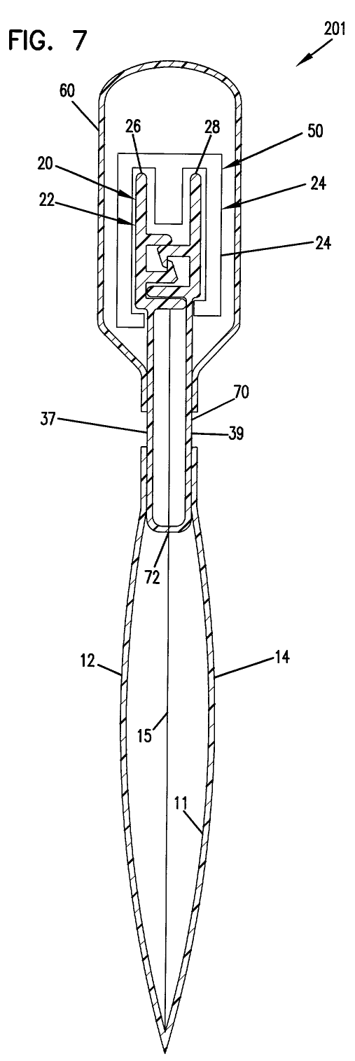

Any of the extended lengths of zipper closure 200, such as extended lengths 201, 202, 203, can be incorporated into flexible packages such as package 10 of FIG. 1 or package 10′ of FIG. 7. When a zipper closure 20 encased in a membrane or envelope in accordance with the present disclosure is used, the polymeric film sheet that provides the side panels 12, 14 (FIGS. 1, 2 and 7) of the package can be sealed to essentially any area or region on second tamper evident-structure 70. In some embodiments, side panels 12, 14 may be sealed to first tamper evident-structure 60; however, in most such situations, the side panels 12, 14 will also be sealed to second tamper evident-structure 70.

FIG. 7 shows package 10′ incorporating extended length of zipper closure 201 of FIG. 4. Package 10′ has zipper closure 20 and slider device 50 encased by first tamper evident-structure 60 and second tamper evident-structure 70. Interior 11 is defined by side panels 12, 14, which are sealed to second tamper evident-structure 70.

Resealable, reclosable packages utilizing an extended length of zipper closure 200 can be manufactured by various methods, such as a vertical form, fill and seal process or a horizontal form, fill and seal process. In both of these processes, the package is manufactured, filled, and sealed by a single process that includes multiple sequential steps.

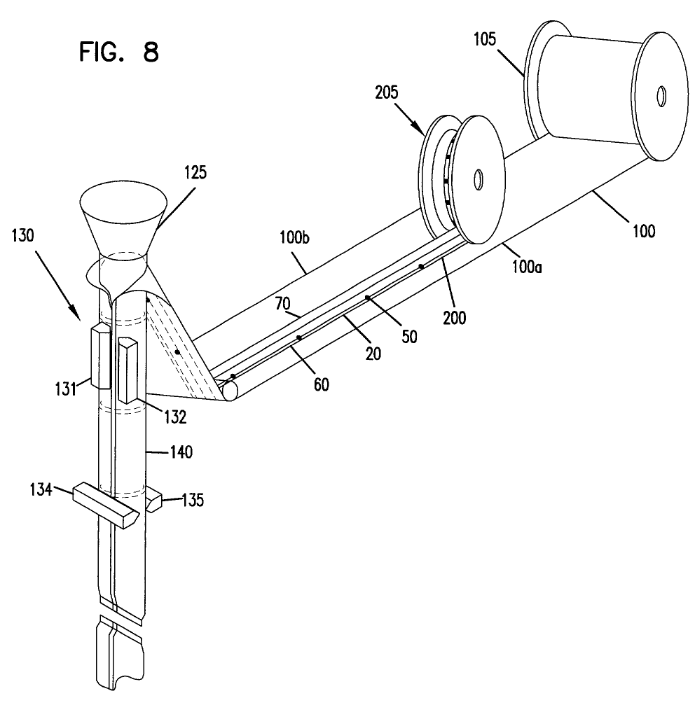

Referring to FIG. 8, a vertical form, fill and seal process is shown. As illustrated in FIG. 8, the process line progresses from right to left so that the final filled package is at the lower left side of FIG. 8.

Polymeric film 100, which will provide the side panels 12, 14 (FIGS. 1, 2 and 7) of the package, is provided on roll 105. The width of polymeric film 100, from first edge 100a to second edge 100b, is approximately twice the distance between side edge 13 (FIG. 1) and side edge 15 (FIGS. 1 and 7) of the finished package. In another embodiment, film 100 may be extruded, cast or otherwise formed immediately prior to this vertical form, fill and seal process, thereby eliminating the step of winding the film after forming the film and then unwinding the film when the packages are made.

An extended length of zipper closure 200, with first closure profile 22 (FIGS. 2 and 7) and second closure profile 24 (FIGS. 2 and 7) interlocked, is provided by spool 205. In another embodiment, extended length of zipper closure 200, which includes zipper closure 20, can be extruded or otherwise formed or assembled immediately prior to use in the vertical form, fill and seal process, thereby eliminating the step of winding the extended length of zipper closure 200 and unwinding when the packages are made. Extended length of zipper closure 20 includes slider device 50 mounted thereon.

Extended length of zipper closure 200 and film 100 are brought into contact with each other and attached together. Preferably, zipper closure 200 is positioned and attached to film 100 in close proximity to first film edge 100a and so that first tamper evident-structure 60 (FIGS. 3 through 7) is positioned closer to film edge 100a than is second tamper evident-structure 70 (FIGS. 3 through 7). In some embodiments, the first tamper evident-structure 60 portion of extended length of zipper closure 200 may extend over edge 100a and off of film 100, leaving only second tamper evident-structure 70 for attachment to film 100.

Although not shown, any attachment mechanism can be used to attach the extended length of zipper closure 200 to film 100; for example, adhesive, solvent, ultrasonics, heat, pressure, or any combination, can be used to seal extended length of zipper closure 200 to film 100. In some embodiments, this attachment may be a continuous, permanent sealing or attachment; the attachment may be a “pre-seal”, that is, is a spot seal or a weak seal; or, no attachment may be made between zipper closure 200 and film 100 at this step of the process. As used herein, the terms “seal” and “preseal” mean that two pieces, such as extended zipper closure 200 and film 100, are adhered to each other, at least with a temporary bond, preferably with a permanent bond. Various nip rolls, idler rolls, pull rolls, tensioners, bars, positioners, and the like can be used to drive, pull, guide position and otherwise manipulate the extended length of zipper closure 200 and film 100 in respect to one another.

Film 100, with extended length of zipper closure 200 preferably attached thereto, moves to column 125 that folds film 100 and provides structure to film 100 during the following steps of the vertical form, fill and seal process. Items to be packaged within the resulting package are deposited into the package through column 125.

Film 100 is folded around column 125 so that side edges 100a, 100b are brought together; there may be a slight overlap of side edges 100a, 100b. The folded film 100 with the zipper closure 200 progresses to seaming station 130, which securely seals film 100 to extended length of zipper closure 200 at each of film side edges 100a, 100b; preferably, film 100 at side edges 100a, 100b is sealed to second tamper evident-structure 70 (FIGS. 3 through 7). Seaming station 130 operates by the application of heat, pressure, or both to film 100. Seaming station 130 includes first seaming bar 131 and second seaming bar 132, either of which, or both, may be heated. Seaming bars 131, 132 extend essentially parallel to column 125, to extended length of zipper closure 200, and to film side edges 100a, 100b.

The sealed film is in the form of a tube or casement 140 that will provide side panels 12, 14 (FIGS. 1, 2 and 7) of the resulting package. Tube 140, with extended length of zipper closure 200 adhered thereto, progresses to transverse sealing bars 134, 135, which provide heat and pressure across tube 140 to provide the side edges 13. 15 (FIG. 1) of the resulting package.

In one embodiment, when filling of the package is desired via column 125, transverse sealing bars 134, 135 first securely provide a first side edge seal for the package. This intermediate package, with one side edge seal, is then filled with items or material, for example, cereal, snack food, fertilizer, potting soil, etc. The items are deposited through column 125 into tube 140 which is a partial package, and then the second opposite side edge seal is made to complete the package.

Alternately, the package may be filled later, such as by the package consumer. In such situations, both the first side edge seal and the second opposite side edge seal are made prior to filling the package.

Transverse sealing bars 134, 135 can be adapted to provide the second side edge seal of one package and simultaneously provide the first side edge seal of an adjacent second package. In some embodiments, different sealing bars may be used to form different side edge seals. Sealing bars 134, 135 can also be adapted to cut apart and separate adjacent packages.

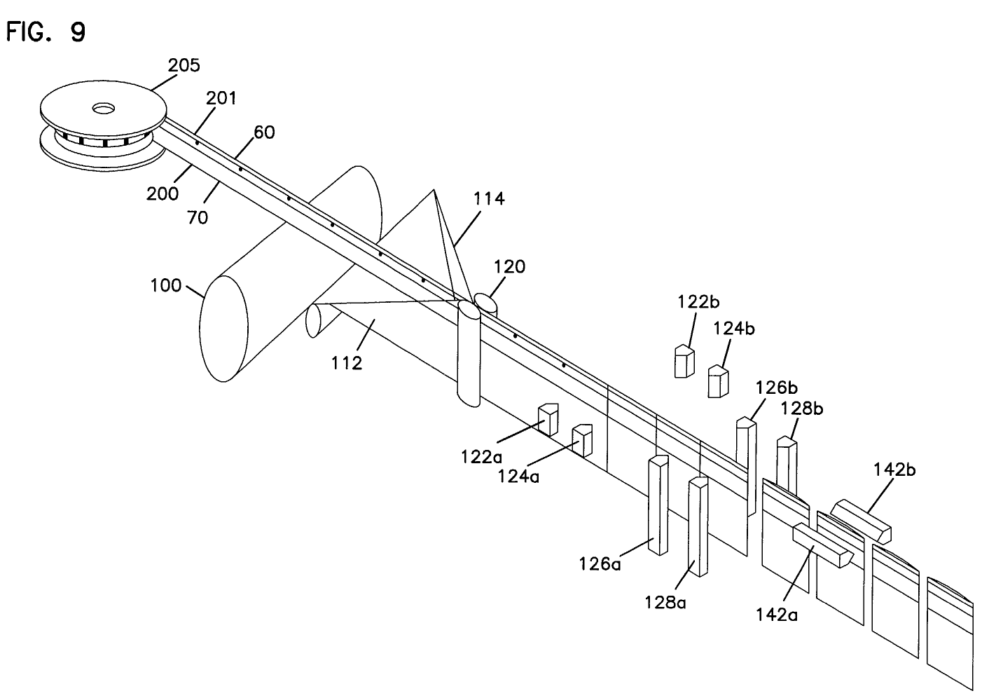

Referring to FIG. 9, a horizontal form, fill and seal process is shown. As illustrated in FIG. 9, the process line progresses from left to right so that the final filled package is at the right side of the figure. Generally with a horizontal form, fill and seal process, the package can be manufactured upside-down so that the filling takes place through the bottom of the package, or, the package can be manufactured mouth-side up so that filling takes place through the top of the package. Throughout this disclosure, the edge of the package having the mouth 30 (FIG. 1) and the zipper closure 20 will be referred to as the “top” of the package. The process depicted in FIG. 9 shows the packages filled through the top of the package.

An extended length of zipper closure 200, such as extended length of zipper closure 201 (FIG. 4), is provided wrapped on a spool 205. In another embodiment, extended length of zipper closure 201, which includes zipper closure 20 and slider device 50, can be extruded or otherwise formed or assembled immediately prior to use in the horizontal form, fill and seal process, thereby eliminating the step of winding the extended length of zipper closure 201 and unwinding when the packages are made.

Polymeric film 100, which will provide the side panels 12, 14 (FIGS. 1, 2 and 7), is provided on a roll. In another embodiment, film 100 can be extruded or otherwise formed immediately before the horizontal form, fill and seal process, thereby eliminating the step of winding the film after forming and then unwinding the film when the packages are made and filled.

Various tensioners, idlers, rollers, positioners, and the like can be used to help control the position and tension of the extended length of zipper closure 200 and of film 100 during the package-making process.

The film 100 is folded to provide first and second film halves 112, 114 which will provide first and second side panels 12, 14 (FIGS. 1, 2 and 7) of the resulting package. This folding can be done by conventional methods, such as a V-board or various rollers. In another embodiment, two separate pieces of film 100 can be used, one for each of side panels 12, 14.

The extended length of zipper closure 201 is fed between the two film halves 112, 114 with first tamper evident-structure 60 (FIGS. 4 and 7) positioned closest to the outer edges of film 100, and second tamper evident-structure 70 (FIGS. 4 and 7) is directed toward the fold between the film halves 112, 114. Guides, fingers, bars, rollers, or anything of the like may be used to manipulate either or both of film halves 112, 114 and extended length of zipper closure 201 to provide proper placement of zipper closure 201. Heated rollers 120 may be used to seal or pre-seal extended length of zipper closure 201 to film halves 112, 114. Typically, film halves 112, 114 are sealed to second tamper evident-structure 70 (FIGS . 4 and 7).

Seal bars 126a, 126b, and 128a, 128b provide vertical seals across the width of the folded film and zipper closure combination. These vertical seals will eventually result in side edges, which are shown as side edges 13, 15 of package 10 in FIG. 1, which extend from the bottom edge to the mouth, such as from bottom edge 17 to mouth 30 (FIG. 1). Typically, these seal bars are heated. In one embodiment, a single set of heated seal bars 126a, 126b is used. In a second embodiment, a plurality of heated seal bars 126a, 126b, 128a, 128b is used. Typically, a seal bar is positioned on each side of the film 100 and zipper closure 201. Heat can be provided from one or both sides of the film; additionally or alternatively, the temperature from one side to another can be the same or can be different. Multiple seal bars, such as shown in FIG. 9, can be heated to different temperatures. The process can be designed so that each seam area is contacted by multiple seal bars, or by only one bar. The seal bars can also be used to cut and separate adjacent packages.

In some embodiments, it may be desired to include a pre-seal section that provides a seal between the extended length of zipper closure 201 and the film 100 but that does not extend the width of film halves 112, 114 or the distance between bottom edge 17 and mouth 30 (FIG. 1) of the resulting package. Pre-seal bars 122a, 122b, 124a, 124b can provide spot seals or the like between film halves 112, 114 and extended length of zipper closure 201.

If needed, seal bars 142a, 142b can be used to securely seal extended length of zipper closure 201 to the film halves 112, 114. These seal bars 142a, 142b can extend the width of the resulting package. Preferably, film halves 112, 114 are sealed to second tamper evident-structure 70 (FIGS. 4 and 7).

If it is desired to fill the package, in this configuration, the extended length of zipper closure 201 is attached to only one of film halves 112, 114. The items to be contained in the resulting package are placed into the package by passing between the zipper closure 201 and film half 112 or 114. Another set of seal bars can then be used to seal the other half, either film half 112 or 114, to extended length of zipper closure 201.

To use the resulting package, such as package 10′ (FIG. 7), made from an extended length of zipper closure 201, which has the zipper closure 20, slider device 50, first tamper evident-structure 60 and second tamper evident-structure 70, each tamper evident-structure 60, 70 must be penetrated in order to access interior 11 of package 10′ .

In one embodiment, first tamper evident-structure 60 is removed from over zipper closure 20 and slider device 50. For example, to use package 10′ of FIG. 7, which incorporates the extended length of zipper closure 201 of FIG. 4, the seal between tamper evident-structure 60 and sealing flanges 37, 39 or second tamper evident-structure 70 would be broken, and first tamper evident-structure 60 removed. In another embodiment, such as for packages made with extended length of zipper closure 202 of FIG. 5, first tamper evident-structure 60 is penetrated by removing tamper evident-structure 60 at weakness 62. Weakness 62 can be a perforation, zip-strip, die line, laser score line, or any mechanism or structure that allows for easy penetration. In yet another embodiment, such as for packages made with extended length of zipper closure 203 of FIG. 6, first tamper evident-structure 60 is penetrated by breaking the seal 64.

After first tamper evident-structure 60 is penetrated, slider device 50 can be moved, if necessary, to unmate first and second mating profiles 22, 24 (FIGS. 2 and 7) and open mouth 30 (FIG. 1). In order to access interior 11 (FIGS. 2 and 7) of the package, second tamper evident-structure 70 must be penetrated. Generally, second tamper evident-structure 70 is penetrated by breaking weakness 72 (FIGS. 4-7). Weakness 72 can be a perforation, zip-strip, a die line, laser score line or any mechanism or structure that allows for easy penetration. After second tamper evident-structure 70 has been penetrated, interior 11 is accessible.

The above specification is believed to provide a complete description of the manufacture and use of particular embodiments of the invention. Many embodiments of the invention can be made.

I claim:

1. A method of manufacturing a reclosable package comprising a zipper closure and a slider device, the method comprising:
(a) providing an extended length of a zipper closure construction, the zipper closure construction comprising:
(i) a first interlocking closure profile and a second interlocking closure profile, each of the closure profiles having a distal end and a sealing flange disposed opposite the distal end;
(ii) a slider device operably mounted on the zipper closure; the slider device constructed and arranged to interlock the first closure profile with the second closure profile when the slider device is moved in a first direction, and to disengage the first closure profile from the second closure profile when the slider device is moved in a second opposite direction, the slider device mounted on the distal ends of the closure profiles;
(iii) a first tamper evident-structure enveloping the slider device and the distal ends of the closure profiles;
(iv) a second tamper evident-structure enveloping the sealing flanges of the closure profiles;
(b) sealing the extended length of zipper closure to a surrounding wall; and
(c) creating edges to form a package interior.

2. The method according to claim 1, wherein the step of sealing the extended length of zipper closure to a surrounding wall comprises:
(a) sealing the extended length of zipper closure to a first film panel and to a second film panel.

3. The method according to claim 1, wherein the step of sealing the extended length of zipper closure to a surrounding wall comprises:
(a) sealing the second tamper evident-structure to the surrounding wall.

4. The method according to claim 1, wherein the step of providing an extended length of a zipper closure construction comprises:
(a) providing an extended length of a zipper closure construction having a notch disposed in the distal ends of the closure profiles.

5. The method according to claim 1, wherein the step of providing an extended length of a zipper closure construction comprises:
(a) providing an extended length of a zipper closure construction wherein the first tamper evident-structure and the second tamper evident-structure together provide an envelope around the closure profiles.

6. The method according to claim 1, wherein the step of sealing the extended length of zipper closure to a surrounding wall comprises:
(a) sealing the extended length of zipper closure to a folded web of film material

7. The method according to claim 1, wherein the step of providing an extended length of a zipper closure construction comprises:
(a) providing an extended length of a zipper closure construction wherein the second tamper evident-structure is integral with the sealing flanges of the closure profiles.

8. The method according to claim 7, wherein the step of providing an extended length of a zipper closure construction comprises:
(a) providing an extended length of a zipper closure construction wherein the first tamper evident-structure is a membrane enveloping the slider device and the distal ends of the closure profiles, and the first tamper-evident structure is sealed to the second tamper evident-structure.

9. The method according to claim 1, wherein the step of providing an extended length of a zipper closure construction comprises:
(a) providing an extended length of a zipper closure construction wherein the first tamper evident-structure and the second tamper evident-structure comprise a seamless tube of material sealed to the sealing flanges of the closure profiles.

10. The method according to claim 1, wherein the steps of sealing the extended length of zipper closure to a surrounding wall, and creating edges to form a package interior comprise:
(a) sealing the extended length of zipper closure to a surrounding wall and creating edges by a vertical form, fill and seal process.

11. The method according to claim 1, wherein the steps of sealing the extended length of zipper closure to a surrounding wall, and creating edges to form a package interior comprise:
(a) sealing the extended length of zipper closure to a surrounding wall and creating edges by a horizontal form, fill and seal process.

12. A flexible, reclosable package comprising:
(a) a surrounding wall defining a package interior;
(b) a zipper closure comprising a first interlocking closure profile and a second interlocking closure profile, each of the closure profiles having a distal end and a sealing flange disposed opposite the distal end, the zipper closure providing access to the package interior;
(c) a slider device operably mounted on the first and second closure profiles; the slider device constructed and arranged to interlock the first closure profile with the second closure profile when the slider device is moved in a first direction, and to disengage the first closure profile from the second closure profile when the slider device is moved in a second opposite direction, the slider device mounted on the distal ends of the closure profiles;
(d) a first tamper evident-structure encasing the distal ends of the closure profiles and the slider device; and
(e) a second tamper evident-structure encasing the sealing flanges of the closure profiles, the second tamper evident-structure positioned between the package interior and the closure profiles, the surrounding wall being sealed to the second tamper evident-structure.

13. The package according to claim 12, wherein:
(a) the second tamper evident-structure is integral with the sealing flanges.

14. A method of using a package, the package comprising a surrounding wall defining a package interior, a zipper closure having a slider device mounted thereon, the zipper closure comprising a first interlocking closure profile having a first sealing flange and a second interlocking closure profile having a second sealing flange, a first tamper evident-structure encasing the zipper closure and the slider device, and a second tamper evident-structure encasing the sealing flanges, the surrounding wall being attached to the second tamper evident-structure; the method comprising:
(a) penetrating the first tamper evident-structure to expose the slider device;
(b) after penetrating the first tamper evident-structure, moving the slider device along the zipper closure to unmate the first and second interlocking closure profiles; and
(c) penetrating the second tamper evident-structure to gain access to the package interior.

15. The method according to claim 14, wherein the step of penetrating the first tamper evident-structure to expose the slider device comprises:
(a) penetrating the first tamper evident-structure by removing at least a portion of the first tamper evident-structure from the zipper closure.

16. The method according to claim 14, wherein the step of penetrating the second tamper evident-structure to gain access to the package interior comprises:
(a) penetrating the second tamper evident-structure by penetrating at a weakness in the second tamper evident-structure.

17. An extended length of a zipper closure comprising:
(a) a first interlocking closure profile and a second interlocking closure profile, each of the closure profiles having a distal end and a sealing flange positioned opposite the distal end;
(b) a slider device operably mounted on the first and second closure profiles; the slider device constructed and arranged to interlock the first closure profile with the second closure profile when the slider device is moved in a first direction, and to disengage the first closure profile from the second closure profile when the slider device is moved in a second opposite direction, the slider device mounted on the distal ends of the closure profiles; and
(c) an envelope encasing the first and second closure profiles and the slider device mounted thereon, the envelope comprising:
(i) a first tamper evident-structure positioned over the slider device and the distal ends of the closure profiles, the first tamper evident-structure connected to the sealing flanges; and
(ii) a second tamper evident-structure connected to the sealing flanges.
